(19) United States
(12) Patent Application Publication
(10) Pub. No.: US 2026/0124689 A1
(43) Pub. Date: May 7, 2026

(54) Workpiece stop arrangement for a circular saw

(71) Applicant: Festool GmbH, Wendlingen am Neckar (DE)

(72) Inventor: Wolfgang Spengler, Neidlingen (DE)

(21) Appl. No.: 19/118,388

(22) PCT Filed: Oct. 2, 2023
(86) PCT No.: PCT/EP2023/077197

§ 371 Date: Apr. 4, 2025

(30) Foreign Application Priority Data
Oct. 7, 2022 (DE) 10 2022 125 930.7

(51) Int. Cl. B23D 47/04

(52) U.S. Cl. CPC B23D 47/04

(57) ABSTRACT

The invention relates to a workpiece stop arrangement for a miter saw or sliding compound miter saw having two stops (20) disposed spaced apart from each other, wherein a spacer area (80) for the passage of a saw blade (76) is formed between the two stops (20). To improve the usability of a circular saw, provision is made for at least one of the stops (20) to have a stop piece (30) having a mount (33), to or in which an exchangeable stop piece (40) is exchangeably attached, wherein the exchangeable stop piece (40) projects at least sectionally beyond the stop piece (30) into the spacer area (80).

The invention relates to a workpiece stop arrangement for a miter saw, in particular a miter saw or sliding compound miter saw, having two stops disposed spaced apart from each other, wherein a spacer area for the passage of a saw blade is formed between the two stops.

U.S. Pat. No. 5,819,619 describes a miter saw having a base part that can be placed on a flat work surface. The base part forms a workpiece support surface. Furthermore, the base part has a swivel arm on its rear section, which can be swiveled about a horizontal swivel axis extending in the direction of the saw blade plane for angled cuts. A saw head is attached to the swivel arm, which saw head can be swiveled about a cutting axis relative to the swivel arm. A workpiece stop arrangement is installed on the workpiece support surface. The workpiece stop arrangement has two stops disposed spaced apart from each other, between which a spacer area is formed, through which the saw blade can pass when the saw head is swiveled about the cutting axis. The stops each have a support that is installed on the workpiece support surface. Each of the supports bears a stop piece that projects beyond the workpiece support surface to establish a contact surface for a workpiece to be machined. The stop pieces can be moved relative to the supports to change the width of the space between the two stop pieces. This is necessary, for instance, when the circular saw is used to make a bevel cut. The two stop pieces must then be spaced further apart to prevent the saw blade from cutting into one of the stop pieces. The greater distance between the stop pieces reduces the effective support surface for the workpiece, which results in poorer positioning, in particular of small workpieces. Furthermore, although the problem is well known, it sometimes happens that a stop piece is inadvertently sawn into. The stop piece must then be replaced, which incurs corresponding costs.

The invention addresses the problem of providing a workpiece stop arrangement of the type mentioned at the beginning, which offers improved usability.

This problem is solved in that at least one of the stops has a stop piece having a mount, to or in which an exchangeable stop piece is exchangeably attached, preferably to form a kinematic unit with the stop piece, which in particular can be uniformly moved, wherein the exchangeable stop piece projects at least sectionally beyond the stop piece into the spacer area.

This new design has several advantages. If the saw blade accidentally cuts into the exchangeable stop piece, for instance during an angled cut or, depending on the design of the miter saw, during a rip cut, the stop piece itself will not be damaged. The exchangeable stop piece can then simply be replaced with a new, undamaged exchangeable stop piece at no great expense.

Furthermore, applications are also conceivable, in which the miter saw or sliding compound miter saw is equipped with an emergency braking system that detects capacitive changes via the saw blade. In such a case, it is advantageous if the exchangeable stop piece is made of a non-conducting material such that the emergency braking system is not triggered when the saw blade cuts into the exchangeable stop piece.

Furthermore, applications are also conceivable, in which a good support of the workpiece in the correct position is desired, particularly in the spacer area between the two stop pieces. It is then advantageous if the exchangeable stop piece(s) protrude(s) as far as possible into the spacer area. The ideal position for the workpiece would be if the entire spacer area is covered by the exchangeable stop piece(s).

For the best possible support of the workpiece, the exchangeable stop piece or exchangeable stop pieces can be deliberately moved far into the spacer area. The miter saw is set to the desired cutting position and then a setting cut into the exchangeable stop piece is performed. As a result, the workpiece is supported on the exchangeable stop piece or exchangeable stop pieces immediately behind the sawing gap during a subsequent workpiece cut.

Such a procedure is particularly advantageous when a large number of consistent workpieces have to be cut at a specific cutting setting. If a different cutting setting is then set, the cut exchangeable stop piece(s) can simply be replaced.

Preferably, at least the area of the exchangeable stop piece that projects into the spacer area is made of a material that is easy to saw, such as a plastic material. Preferably, the entire exchangeable stop piece is designed as a plastic part, in particular as an injection-molded plastic part. The integral design of the exchangeable stop piece not only reduces the cost of this component, but also achieves the high dimensional accuracy required for a precise workpiece system.

Preferably, the exchangeable stop piece is made of a non-conducting material, for instance a plastic material, i.e., it is designed as a plastic part, in particular as an injection-molded plastic part. The design of the exchangeable stop piece as a plastic part prevents an emergency braking system of the miter saw from being falsely triggered in the event of contact of the saw blade with the exchangeable stop piece.

With a miter saw, the saw blade can be moved between two extreme swivel positions in a swivel range. Therefore, preferably the stop pieces can only be moved towards each other to such an extent that they cannot enter the swivel range of the saw blade, which can be achieved by means of corresponding limit stops. This reliably prevents the stop piece itself from being cut into. This means that only the exchangeable stop piece(s) can be cut in the extreme swivel positions.

According to a preferred variant of the invention, provision may be made for both stop pieces to each exchangeably bear an exchangeable stop piece, wherein the exchangeable stop pieces project into the spacer area facing each other, and for a sawing gap for the passage of the saw blade to be formed or to be formable between the longitudinal ends of the exchangeable stop pieces. With such an arrangement, the user can move the two stop pieces and the exchangeable stop piece held thereon towards each other and set the desired sawing gap. The fact that both stop pieces are fitted with exchangeable stop pieces prevents sawing into one of the stop pieces depending on the inclination of the saw blade.

However, it is also conceivable that an exchangeable stop piece that bridges the spacer area is exchangeably connected to both stop pieces. Such an arrangement is particularly useful if, as described above, an ideal workpiece contact surface is desired, i.e. the workpiece support is brought right up to the sawing gap. When the miter saw is set to the desired sawing position, the saw blade can be used to cut through the exchangeable stop piece using a setting cut. As the exchangeable stop piece is held on both sides of the stop pieces, the resulting sections of the exchangeable stop piece remain on the respective assigned stop pieces. The workpiece can then be positioned and cut.

For an ideal support of the workpiece, provision may be made for the stop piece(s) to have a front-end workpiece contact surface that is/are aligned with a front-end contact surface of the exchangeable stop piece, preferably merging flush with the latter, or for both stop pieces to have a front-end workpiece contact surface that is aligned with front-end contact surfaces of the two exchangeable stop pieces.

It is particularly advantageous if the exchangeable stop piece, which is in particular connected to both stop pieces in an exchangeable manner, forms a flat or plane front contact surface for supporting a workpiece. In this way, the exchangeable stop piece, through which the setting cut has been made, forms a kind of splinter guard and prevents the workpiece from tearing in the area of the sawing gap.

One conceivable variant of the invention is such that at least one of the stop pieces has a linear guide having one or more guide elements, which is/are designed for moving the stop piece relative to a fastening section in the width direction of the spacer area, wherein preferably provision is made for the sliding motion of the exchangeable stop piece in the direction of the spacer area to be limited by means of a limit stop.

For an exact and positionally accurate assignment of the exchangeable stop piece to the stop piece, provision may be made for a centering connection to be effective between the stop piece and the assigned exchangeable stop piece, preferably in the area of the mount, wherein the centering connection has a centering mount with which a centering lug engages, wherein preferably provision is made for the centering connection to have two centering mounts disposed spaced apart from each other, with each of which a centering lug engages. In particular, the centering connection can be designed in such a way that, in the assembly position, a front-end workpiece contact surface of the stop piece is aligned with a front-end contact surface of the exchangeable stop piece. The centering connection can also be such that it forms a sliding guide between the stop piece and the exchangeable stop piece, such that the exchangeable stop piece can be pushed onto the stop piece until it reaches its mounting position, for instance until it strikes against a stop provided for this purpose on the stop piece.

Preferably, the two centering mounts of the centering connection can be disposed spaced apart from each other in the direction perpendicular to the workpiece support surface of the table to achieve a sufficient support distance and thus good moment support in this direction.

A workpiece stop arrangement according to the invention can be characterized in that the exchangeable stop piece has at least one fastening mount, into which a fastening lug of the stop piece is inserted. In this way, a stable form-fitting connection is established between the stop piece and the exchangeable stop piece. Preferably, the fastening attachment is oriented in such a way that the insertion motion of the fastening lug into the fastening mount is oriented in the direction of the workpiece support surface of the table. This results in a form-fitting support of the exchangeable stop piece on the stop piece in the horizontal direction. Preferably, the insertion motion is parallel to the support surface such that the exchangeable stop piece can be easily attached to the stop piece that has already been installed. Particularly preferably at least two fastening lugs are provided, which can be inserted into assigned fastening mounts.

If provision is made for the exchangeable stop piece to have a support section, which is seated on a support surface of the stop piece, then an additional support of the exchangeable stop piece can be achieved. Preferably, the support surface is oriented in the direction of the workpiece support surface, preferably in parallel thereto. This renders a safe transfer of the forces applied to the workpiece during operation possible.

One possible embodiment of the invention is such that the stop piece bears a clamping lever on its end facing away from the workpiece contact surface, which clamping lever can be swiveled about a swivel axis extending transverse to the workpiece contact surface using a swivel bearing, wherein the stop piece has a clamping piece, which can be moved between a release position and a clamping position by an eccentric of the clamping lever.

The problem of the invention is also solved by an exchangeable stop piece for a workpiece stop arrangement, having a base body, which has a front contact surface for the contact of a workpiece to be machined, wherein the base body has a holding section having one or more fastening mounts and a seating surface offset with respect to the contact surface. The retaining section of the exchangeable stop piece can be exchangeably attached to a stop piece and connected to the stop piece via the fastening mounts. In this way, the benefits of use already mentioned above are achieved. In particular, if the exchangeable stop piece is damaged, it can be replaced by an undamaged exchangeable stop piece to restore the usability of the stop for the workpiece.

If provision is made for the base body to comprise two spaced-apart fastening mounts in the form of cut-outs or recesses in the retaining section, then a stable support of the exchangeable stop piece on the stop piece can be achieved. In particular, fastening pieces or fastening lugs of the stop piece can then be inserted into the fastening mounts. Of course, the fastening lugs on the exchangeable stop piece and the fastening mounts on the stop piece can also be provided with the same effect in (kinematic) reverse.

The exchangeable stop piece can then be easily installed on the stop piece if provision is made for the retaining section to be designed as an attachment cantilevered from the base body, in particular as a cantilevered fastening arm.

For an exact positioning of the exchangeable stop piece on a stop piece, provision may be made for the base body to have two spaced-apart centering lugs, which are disposed spaced apart from the at least one fastening mount.

An exchangeable stop piece according to the invention can be such that the base body has a transition section adjoining the contact surface, that the seat surface adjoins the transition section, and that the seat surface is disposed offset in the direction towards the rear of the exchangeable stop piece relative to the contact surface, preferably in parallel thereto. Accordingly, the seat surface of the exchangeable stop piece can be placed on the back of a counter surface of the stop piece and securely supported there. Then the contact surface, which is offset from the seat surface, may be in alignment with a front workpiece contact surface of the stop piece and precisely aligned therewith. This facilitates achieving a precise alignment of the exchangeable stop piece on the stop piece.

For improved force transfer during operation, provision may be made for the base body to bear a support section, which projects from the rear beyond the base body in the opposite direction to the contact surface and which has a mating support surface.

A preferred design of the exchangeable stop piece can be such that the base body, on its area facing away from the holding section, has an end section having a body edge, which body edge forms the longitudinal end of the exchangeable stop piece to form a boundary of a spacer area for the passage of a saw blade. Alternatively, however, it is also possible for the base body to bear two retaining sections on opposite sides, each of which has at least one fastening mount. As already explained above, such an exchangeable stop piece can be used to bridge the entire spacer area between two stops, wherein then a setting cut is used to cut therethrough.

The invention is explained in greater detail below based on an exemplary embodiment shown in the figures. In the figures:

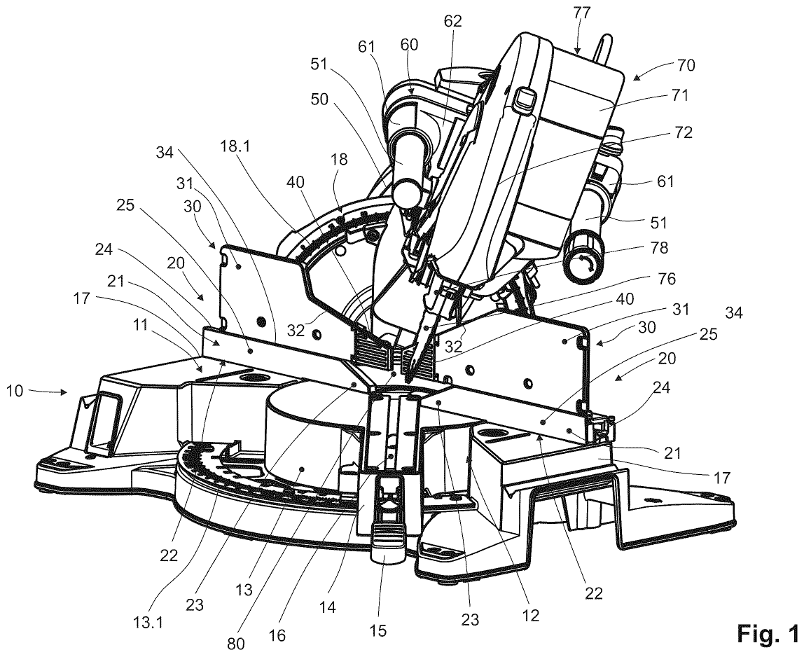

FIG. 1 shows a perspective view from the front right, of a miter saw, namely a sliding compound miter saw,

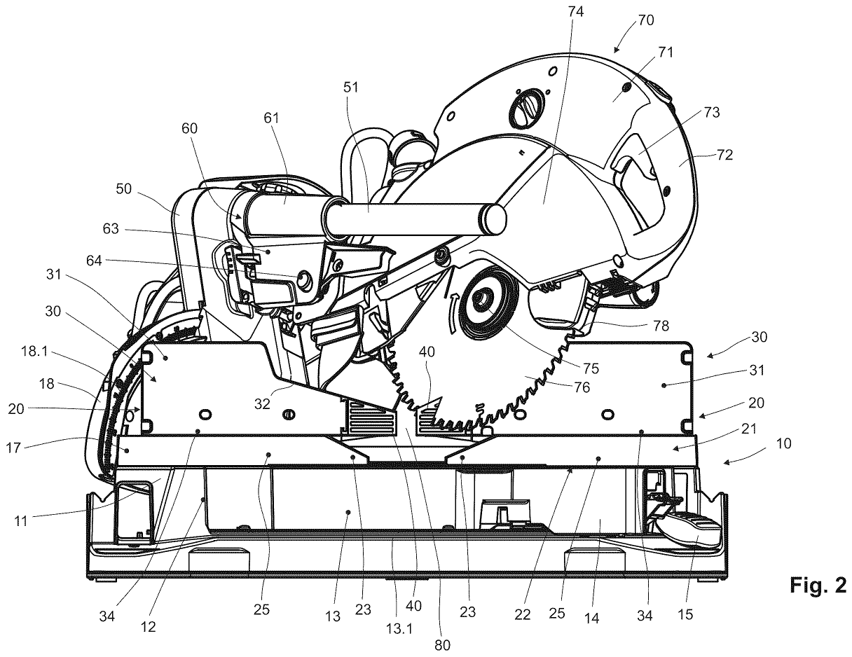

FIG. 2 shows a perspective front view from the front left, of the miter saw of FIG. 1

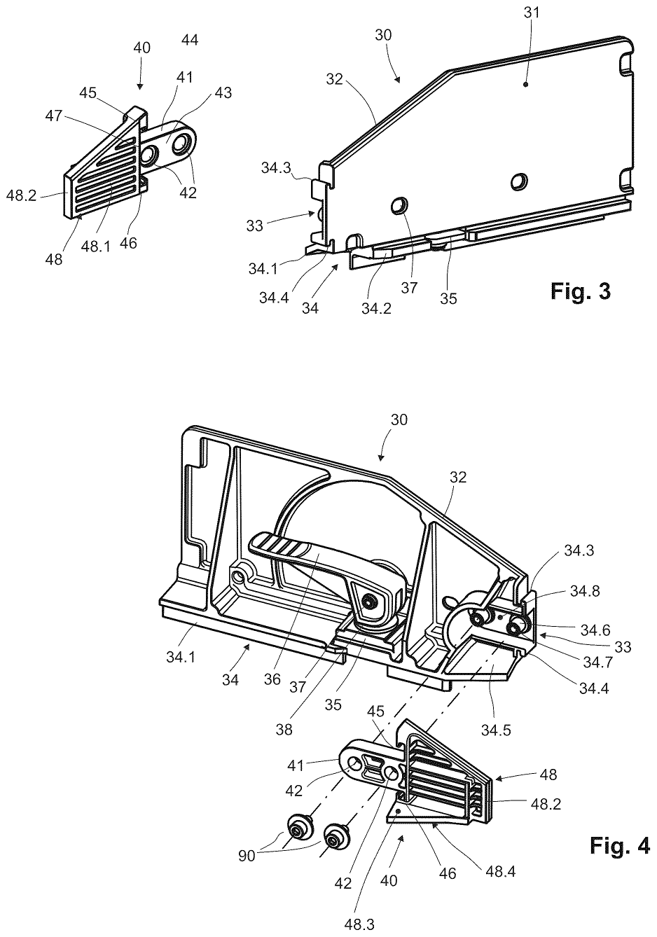

FIG. 3 shows a perspective view of a stop having a stop piece and an exchangeable stop piece,

FIG. 4 shows a perspective rear view of the arrangement of FIG. 3,

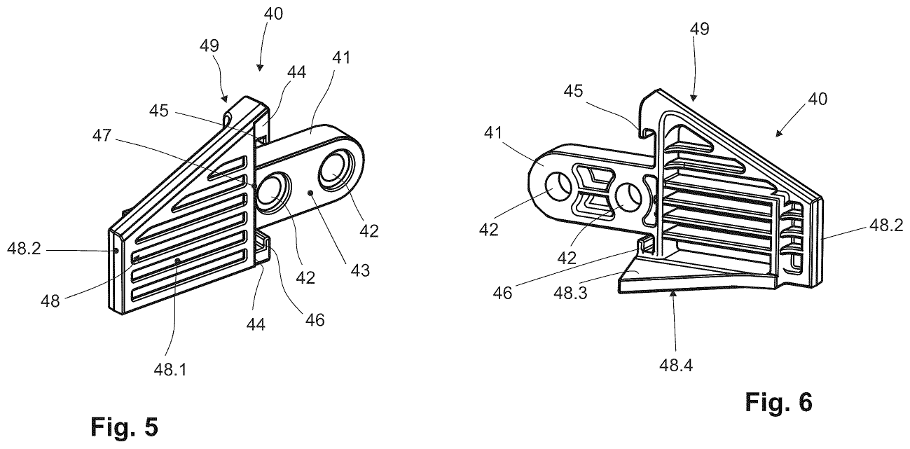

FIG. 5 shows a perspective front view of the exchangeable stop piece of FIGS. 3 and 4,

FIG. 6 shows a perspective rear view of the exchangeable stop piece of FIG. 5 and

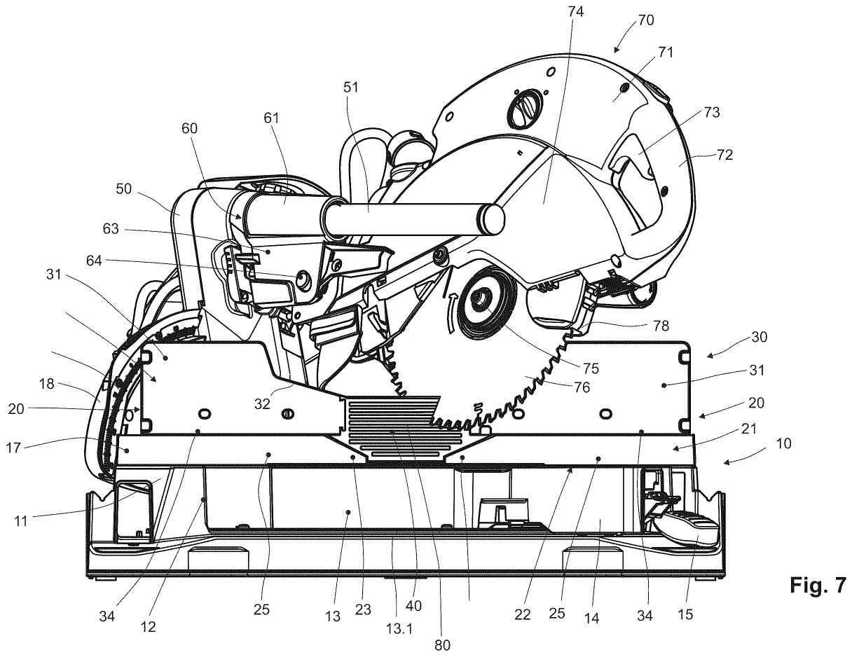

FIG. 7 shows a perspective view of the miter saw of FIGS. 1 and 2, but with an alternative exchangeable stop piece.

FIG. 1 shows a miter saw, namely a sliding compound miter saw, which has a base part 10. The base part 10 has a base frame, which can be used to set up the sliding compound miter saw on a supporting surface. The base part 10 has a mount 12. A rotary unit 13 can be swivel-mounted in this mount 12. The axis of rotation of the rotary unit 13 extends vertically to the supporting surface, on which the sliding compound miter saw can be set up. To swivel the rotary unit 13, an arm 14 is connected to the rotary unit 13, which projects forward beyond the base part 10. The arm 14 accommodates a locking mechanism 15. This locking mechanism 15 can be used to lock the set swivel position of the rotary unit 13.

The table 11 and the rotary unit 13 in conjunction form a workpiece support surface, on which a workpiece can be placed. A saw slot 16 is provided in the arm 14 and in the rotary unit 13. A saw blade 76 of the miter saw can plunge into this saw slot 16.

Two stops 20 can be installed in the area of the workpiece support surface, as shown in FIG. 1. The stops 20 can be positioned on both sides of the saw slot 16 in a movable manner. A spacer area 80 is formed between the two stops 20, which spacer area adjoins the saw slot 16 and through which the saw blade 76 can be guided when it performs a separating cut.

The stops 20 can be designed such that they each have a support 21, which sits on the workpiece support surface by means of a connecting section 22 and can be connected to the table 11. The two supports 21 are disposed on either side of the saw slot 16, each ending with an end piece 23.

As FIG. 1 shows, the supports 21 have guides 24, to which a stop piece 30 can be adjustably attached. The movement of the stop piece 30 relative to the support 21 occurs horizontally and in the direction of the longitudinal extension of the support 21. FIGS. 3 and 4 illustrate that the stop pieces 30 can be equipped with a linear guide 34 for this purpose. The linear guide 34 may have two guide elements 34.1, 34.2, which engage with the guide 24 of the support 21.

At the front, each support 21 has a stop surface 25 for supporting a workpiece. When installed, the two stop surfaces 25 of the supports 21 are aligned with each other.

FIGS. 1 and 2 also show that the base part 10 has a support 18 to which a swivel arm 50 is attached in a swiveling manner. For this purpose, a swivel bearing having a swivel axis is used, which swivel bearing connects the swivel arm 50 and the support 18. The swivel axis extends in a horizontal direction and in parallel to the workpiece support surface of the table 11. Preferably, the swivel axis is aligned with the saw slot 16.

FIG. 1 illustrates that the support 18 can comprise a scaling 18.1. The set swivel position of the swivel arm 50 can be taken from the scaling 18.1.

FIG. 1 shows an adjusting device 60 can be attached to the swivel arm 50. The adjusting device 60 can be moved linearly on a guide 51 of the swivel arm 20 in the direction of the longitudinal extension of the saw slot 16. For instance, as FIG. 1 shows, the swivel arm 50 can comprise two cantilevered guide rods extending in parallel to each other and forming the guides 51. The adjusting device 60 is guided on the guides 51 using sleeve-shaped guide necks 61. The guide necks 61 are interconnected via a connecting section 62.

The adjusting device 60 can comprise a support 63, to which a saw head 70 is attached in a swiveling manner. Preferably, the saw head 70 is swivel-connected to the support 63 by means of a miter bearing 64. The swivel axis of the miter bearing 64 extends at right angles to the swivel axis of the swivel arm 50 and horizontally in one position of the saw head, i.e., in parallel to the workpiece support surface of the table 11.

The saw head 70 has a housing 71, on which a handle 72 having a switch 73 can be disposed. The switch 73 is used to activate a motor 77 of the saw head 70. The motor 70 can drive a saw-blade holder 75 and in that way a saw blade 76 connected to the saw-blade holder 75.

The saw blade holder 75 disposed on the saw head 70 defines a saw blade plane, in which a saw blade 76, which can be secured on the saw blade holder 75, can be rotated.

FIG. 1 illustrates that the saw head 70 can comprise a protective saw blade cover 74. The protective saw blade cover 74 encloses the cutting edge of the saw blade 76 in the area of the top face of the circular saw and thus forms an access guard.

An adjustable protective cover 78 is connected to the protective saw blade cover 74. It can be swivel-connected to the protective saw blade cover 74 in a known manner. The adjustable protective cover 78 can be used to enclose the lower part of the cutting edge of the saw blade 76. The adjustable protective cover 78 can be swiveled to expose the cutting area of the saw blade 76 during operation. In the state, in which the adjustable protective cover exposes the underside of the saw blade 46, it is preferably at least partially swiveled into the housing 71.

FIGS. 1 and 2 show the positioning of the saw head 70 in a position swiveled at least partially downwards about the miter axis of the miter bearing 64 in the direction of the workpiece support surface, wherein the adjusting device 60 is in a rear stop position.

In the setting shown in FIGS. 1 and 2, the stop pieces 30 are locked by means of their linear guide 34 relative to the fastening section 17 across the width of the spacer area 80 in such a way that they are displaced all the way in the direction of the spacer area 80. The sliding motion of the stop pieces 30 and/or the exchangeable stop pieces 40 in the direction of the spacer area 80 is therefore limited by means of a limit stop.

As FIGS. 1 and 2 illustrate, the stop pieces 30 do not extend into the saw blade plane in the position displaced all the way in the direction of the spacer area 80, i.e. in the direction of the saw blade plane. Advantageously, the displacement of the stop pieces 30 is limited in such a way that they are not cut by the saw blade plane regardless of the alignment of the saw blade plane. In other words, only the exchangeable stop pieces 40 extend into the saw blade plane in at least one orientation of the saw blade plane in a position of the stop piece 30 displaced all the way in the direction of the spacer area 80.

As FIGS. 3 and 4 further illustrate, the stop piece 30 has a workpiece contact surface 31 at the front, which is preferably plane and which can preferably be disposed such that it is in alignment with the stop surface 25 of the assigned support 21.

The stop piece 30 can preferably be designed in such a way that it has an inclined surface 32 on its end facing away from the linear guide 34, which slopes down towards the spacer area 80 and thus towards the saw slot 16.

FIG. 4 illustrates that the stop piece 30 has a mount 33. Preferably, the mount 33 is designed such that it is accessible from the rear of the stop piece 30. At least one fastening lug 34.6 can be provided in the area of the mount 33. In this exemplary embodiment, two fastening lugs 34.6 are used. In one possible embodiment, the fastening lugs 34.6 are integrally connected to the component of the stop piece 30 forming the workpiece contact surface 31. Preferably, the fastening lugs 34.6 are in the form of molded cylinders. It is conceivable, as shown in FIG. 4, that the one fastening lug 34.6 or the several fastening lugs 34.6 have screw mounts 34.7. The central longitudinal axis of the screw mounts 34.7 may extend perpendicular to the workpiece contact surface 31.

The mount 33 may have a seat contact surface 34.8 connected to the at least one fastening lug 34.6, which seat contact surface is preferably aligned in parallel to the workpiece contact surface 31 at the front.

In the area of the mount 33, centering mounts 34.3, 34.4 can also be provided, which are preferably integrally formed on the body forming the workpiece contact surface 31. The centering mounts 34.3, 34.4 are disposed spaced apart from each other in the direction perpendicular to the workpiece support surface of the table 11, such that a support distance is established between the centering mounts 34.3 and 34.4.

FIG. 4 further illustrates that the stop piece 30 bears an adjustable clamping piece 35 in the area of the guide 34. The clamping piece 35 is disposed and designed in such a way that it blocks the displacement of the stop piece 30 relative to the support 21 in a clamping position. A clamping lever 36 may interact with the clamping piece 35. The clamping lever 36 is swivel-connected to the stop piece 30 via a swivel bearing 37. The clamping lever 36 is preferably disposed on the rear end of the stop piece 30.

FIG. 4 also shows that the clamping lever 36 has an eccentric 38 that interacts with the clamping piece 35. In the locked clamping position shown in FIG. 4, the eccentric 38 has moved the clamping piece 35 into its clamping position. If the clamping lever 36 is swiveled clockwise, the clamping piece 35 is unblocked and the clamping position is released.

FIGS. 3 and 4 illustrate that an exchangeable stop piece 40 can be exchangeably connected to the stop piece 30. The exchangeable stop piece 40 is shown in more detail in FIGS. 5 and 6. As these illustrations show, the exchangeable stop piece 40 has a base body 49, on which a retaining section 41 can be formed in the form of a cantilevered arm.

The holding section 41 can be equipped with one or more fastening mounts 42. As shown in this exemplary embodiment, the fastening mounts 42 can be designed as drilled holes.

The holding section 41 has a seating surface 43 at the front, which preferably extends in parallel to the workpiece contact surface 31 of the stop piece 30 when the exchangeable stop piece 40 is installed.

The design of the exchangeable stop piece 40 can be such that the seat surface 43 merges into a front contact surface 48 via a shoulder 44 of a transition section 47.

As shown in FIGS. 5 and 6, a conceivable design variant of the contact surface 48 can be such that grooves 48.1 are disposed in the contact surface 48. The grooves 48.1 are used to improve the manufacturability of the exchangeable stop piece 40.

The design of the exchangeable stop piece 40 can be such that the exchangeable stop piece 40 has centering projections 45, 46, which are designed to interact with the centering mounts 34.3, 34.4. Advantageously, centering mounts 34.3, 34.4 and centering lugs 45, 46 interact such that the exchangeable stop piece 40 can be displaced perpendicular to the contact surface 48 and/or the workpiece contact surface 31.

The exchangeable stop piece 40 forms a longitudinal end 48.2 on its area facing away from the holding section 41, which end can be positioned laterally of the saw slot 16 in the assembled state.

In the area of its rear end, the exchangeable stop piece 40 can be equipped with a support section 48.3, which is integrally molded to the base body 49 preferably in a cantilevered manner. The support section 48.3 forms a mating support surface on its underside, which rests on the support surface 34.5 of the stop piece 30.

To install the exchangeable stop piece 40 on the stop piece 30, the exchangeable stop piece 40 is attached to the back of the stop piece 30 in the area of the mount 33. The centering lugs 45, 46 are located at the rear behind the centering mounts 34.3, 34.4. The centering projections 45, 46 of the exchangeable stop piece 40 can now be pushed onto the centering mounts 34.3, 34.4, wherein the sliding motion is perpendicular to the workpiece contact surface 31 from the rear to the front. The sliding motion of the exchangeable stop piece 40 is blocked by the seat surface 43, which abuts against the seat contact surface 34.8.

In the assembled state, the fastening lugs 34.6 are inserted into the fastening mounts 42. Finally, fastening screws 90 can now be screwed into the screw mounts 34.7 of the stop piece 30, thus securing the exchangeable stop piece 40 at the stop piece 30.

In addition, provision may be made for an adjusting means, for instance an adjusting screw (not shown in the figures), preferably a grub screw, to be provided on the holding section 41 for aligning the contact surface 48 relative to the workpiece contact surface 31. This is of great importance for the exact positioning of the workpiece on the stop 20 and/or the stop piece 30. The adjustment means can then be used to align the retaining section 41 in the mount 33, for instance on the seat contact surface 34.8.

FIG. 2 shows a setting of the miter saw, in which the rotating part 13 has been swiveled all the way in one direction. Furthermore, the swivel arm 50 was used to swivel the saw head 70 relative to the base part 10. This is an example of a possible desired cutting position. The stops 20 can then be set. For this purpose, the stop pieces 30 with the exchangeable stop piece 41 attached thereto can be moved towards each other such that the gap area between the longitudinal ends 48.2 of the exchangeable stop pieces 40 is reduced.

The workpiece to be machined can then be placed against the stop surfaces 25 of the supports 21 and the aligned workpiece contact surfaces 31 of the stop pieces 30 and against the front contact surfaces 48 of the exchangeable stop pieces 40 and rest against them. Finally, a separating cut can now be made in the workpiece using the saw blade 76.

If a stop 20 is inadvertently set incorrectly such that an exchangeable stop piece 40 protrudes into the working area of the saw blade 76, the exchangeable stop piece will be damaged by the saw blade 76 during the separating cut. The damaged exchangeable stop piece 40 can then be easily replaced by a new exchangeable stop piece 40.

FIG. 7 shows a sliding compound miter saw having a further design variant of an exchangeable stop piece 40. The design of this sliding compound miter saw is largely identical to the design of the sliding compound miter saw of FIGS. 1 and 2. In this respect, reference can be made to the above statements to avoid repetition. Therefore, only the differences will be discussed below.

As FIG. 7 shows, the entire spacer area 80 is covered by the exchangeable stop piece 40 and attached to the stop pieces 30 on both sides, i.e. on both sides of the saw blade plane. In other words, the saw blade plane intersects the exchangeable stop piece 40 such that the exchangeable stop piece 40 is cut into when making a separating cut to form a so-called zero-gap stop. With a zero-gap stop, there is no gap between the workpiece stop arrangement, in particular the stop 20, and the saw blade 76. This creates an ideal support for the workpiece in the spacer area 80.

To produce the zero-gap stop, the saw head 70, set to the desired cutting angle as shown in FIG. 7, cuts through the exchangeable stop piece 40, which is attached on both sides, using a setting cut. As a result, the workpiece is supported on the exchangeable stop piece 40 immediately behind the sawing gap during a subsequent workpiece cut.

In the arrangement shown in FIG. 7, the stops 20 are locked in a position displaced all the way in the direction of the spacer area 80, i.e., in the direction of the saw blade plane, such that there is a defined lateral edge and a defined width of the spacer area 80 for mounting an exchangeable stop piece 40 adapted to this edge and this distance. Advantageously, the exchangeable stop piece 40 extends from the stop pieces 30 into the area of the workpiece support surface.

1-15. (canceled)

16. A workpiece stop arrangement for a miter saw, comprising:
first and second stops spaced apart from each other to form a spacer area for the passage of a saw blade between the first and second stops;
wherein the first stop includes a first stop piece including a first mount and a first exchangeable stop piece exchangeably attached to the first mount, the first exchangeable stop piece projecting at least partially beyond the first stop piece into the spacer area.

17. The workpiece stop arrangement of claim 16, wherein:
the second stop includes a second stop piece including a second mount and a second exchangeable stop piece exchangeably attached to the second mount;
wherein both the first and second exchangeable stop pieces project into the spacer area facing each other and a sawing gap for the passage of the saw blade is formed between longitudinal ends of the exchangeable stop pieces.

18. The workpiece stop arrangement of claim 16, wherein:
the second stop includes a second stop piece including a second mount;
wherein the first exchangeable stop piece bridges the spacer area and is exchangeably connected to both the first and second stop pieces.

19. The workpiece stop arrangement of claim 16, wherein:
the first stop piece has a front-end workpiece contact surface and the first exchangeable stop piece has a front-end contact surface aligned with the front-end workpiece contact surface.

20. The workpiece stop arrangement of claim 16, wherein:
the first stop piece is connected to the first exchangeable stop piece by a centering connection including a centering lug on one of the first stop piece or the first exchangeable stop piece and a centering mount on the other of the first stop piece or the first exchangeable stop piece.

21. The workpiece stop arrangement of claim 20, wherein:
the first stop piece is connected to the first exchangeable stop piece by two centering connections spaced apart from each other.

22. The workpiece stop arrangement of claim 16, wherein:
the first exchangeable stop piece includes at least one fastening mount; and
the first stop piece includes a fastening lug inserted into the fastening mount.

23. The workpiece stop arrangement of claim 16, wherein:
the first stop piece includes a support surface; and
the first exchangeable stop piece includes a support section seated on the support surface.

24. An exchangeable stop piece for a workpiece stop arrangement for a miter saw, comprising:
a base body including a front contact surface configured to contact a workpiece to be machined, the base body including a holding section including one or more fastening mounts and a seating surface offset with respect to the contact surface.

25. The exchangeable stop piece of claim 24, wherein:
the one or more fastening mounts comprises two spaced-apart fastening mounts formed as cut-outs or recesses in the holding section.

26. The exchangeable stop piece of claim 24, wherein:
the holding section is configured as a fastening arm cantilevered from the base body.

27. The exchangeable stop piece of claim 24, wherein:
the base body includes two spaced-apart centering lugs disposed spaced apart from the one or more fastening mounts.

28. The exchangeable stop piece of claim 24, wherein:
the base body includes a transition section adjoining the front contact surface, wherein the seating surface is disposed offset in a direction towards a rear of the exchangeable stop piece relative to the front contact surface.

29. The exchangeable stop piece of claim 28, wherein:
the seating surface is parallel to the front contact surface.

30. The exchangeable stop piece of claim 24, further comprising:
a support section projecting rearward from the base body, the support section including a mating support surface.

31. The exchangeable stop piece of claim 24, wherein:
the base body includes an end section projecting oppositely from the holding section, the end section including a body edge forming a longitudinal end of the exchangeable stop piece to form a boundary of a spacer area for the passage of a saw blade of the miter saw.

32. The exchangeable stop piece of claim 24, wherein:
the base body includes a second holding section projecting oppositely from the first mentioned holding section, the second holding section including a further one or more fastening mounts.

33. A miter saw, comprising:
a base part including a support and a rotary unit, the rotary unit forming a workpiece support surface and having an axis of rotation oriented perpendicular to the workpiece support surface;
a swivel arm swivel connected to the support such that the swivel arm can be swiveled about a swivel axis oriented perpendicular to the axis of rotation;
a saw head carried by the swivel arm and configured to receive a saw blade on a saw blade holder defining a saw blade plane, the saw head being coupled to the swivel arm about a miter axis of a miter bearing such that the saw head can swivel about the miter axis;
wherein a saw slot is formed in the workpiece support surface of the rotary unit along the saw blade plane to receive the saw blade at least partially during a separating cut; and
a workpiece stop arrangement including an exchangeable stop piece, the exchangeable stop piece including a base body including a front contact surface configured to contact a workpiece to be cut by the saw blade, the base body including a holding section including one or more fastening mounts and a seating surface offset with respect to the front contact surface.

34. The miter saw of claim 33, wherein:
the workpiece stop arrangement includes first and second stops spaced apart from each other to form a spacer area for the passage of the saw blade between the first and second stops;
the first stop includes a first stop piece including a first mount and the exchangeable stop piece is exchangeably attached to the first mount, the exchangeable stop piece projecting at least partially beyond the first stop piece into the spacer area;
the first stop piece includes a linear guide having one or more guide elements configured to allow movement of the stop piece in a width direction of the spacer area; and
sliding motion of the first stop piece into the spacer area is limited by engagement of a limit stop such that the exchangeable stop piece does not extend into the saw blade plane when the limit stop is engaged.

35. The miter saw of claim 33, wherein:
the workpiece stop arrangement includes first and second stops spaced apart from each other to form a spacer area for the passage of the saw blade between the first and second stops;
the first stop includes a first stop piece including a first mount and the exchangeable stop piece is exchangeably attached to the first mount, the exchangeable stop piece projecting at least partially beyond the first stop piece into the spacer area;
the first stop piece includes a linear guide having one or more guide elements configured to allow movement of the stop piece in a width direction of the spacer area; and
sliding motion of the first stop piece into the spacer area is limited by engagement of a limit stop such that the exchangeable stop piece does extend into the saw blade plane when the limit stop is engaged.
